(19) United States
(12) Patent Application Publication
(10) Pub. No.: US 2016/0275550 A1
(43) Pub. Date: Sep. 22, 2016

(54) INFORMATION PROCESSING DEVICE AND INFORMATION PROCESSING METHOD

(71) Applicant: Panasonic Intellectual Property Management Co., Ltd., Osaka (JP)

(72) Inventor: Takayuki FUKUI, Osaka (JP)

(21) Appl. No.: 15/072,805

(22) Filed: Mar. 17, 2016

(30) Foreign Application Priority Data
Mar. 19, 2015 (JP) 2015-056721
Jan. 27, 2016 (JP) 2016-013602

(51) Int. Cl. G06Q 30/02; G01C 21/34; G05B 15/02

(52) U.S. Cl. CPC G06Q 30/0246; G05B 15/02; G06Q 30/0266; G01C 21/34

(57) ABSTRACT

An information processing device includes a location information receiver and a memory. The location information receiver acquires current location information indicating a current location of the information processing device. The memory stores a distance condition value for each type of a facility. The distance condition value indicates a distance determined based on the facility. The information processing device further includes a facility information receiver that receives facility information. The facility information contains facility location information indicating a location of the facility, and identification information identifying the type of the facility. The information processing device further includes a CPU and a transmitter. The CPU generates a conversion result indicating that a user is determined to have stayed in the facility, based on the current location information, the facility location information, and the distance condition value. The transmitter transmits the conversion result to an external apparatus.

### BACKGROUND

1. Technical Field

The present disclosure relates to an information processing device and an information processing method that make it possible to estimate advertising effectiveness.

2. Description of the Related Art

PTL 1 discloses an advertising system that measures the effect of attracting customers, which is produced by the use of signage on which an advertisement is displayed. This advertising system includes a wireless LAN communication unit on a customer-sending-side and a wireless LAN communication unit on a customer-receiving side. The customer-sending side wireless LAN communication unit is disposed at a position corresponding to a digital signage on which advertising content is displayed. The customer-receiving side wireless LAN communication unit is disposed in a commercial space that is a target for the advertising content. The advertising system further includes a customer-attracting-result update unit. When the customer-attracting-result update unit detects that a wireless terminal enters a communication area of the customer-attracting side wireless LAN communication unit and then enters a communication area of the customer-receiving side wireless LAN communication unit, the customer-attracting-result update unit updates the information that includes a customer attracting result obtained by the use of the advertising content. With this advertising system, the advertising effectiveness produced by the digital signage can be determined.

### CITATION LIST

### Patent Literature

PTL 1: Unexamined Japanese Patent Publication No. 2014-157497

### SUMMARY

The present disclosure provides an information processing device and an information processing method that make it possible to estimate advertising effects of distributed advertisements.

According to a first aspect of the present disclosure, an information processing device includes a location information receiver and a memory. The location information receiver acquires current location information that indicates a current location of the information processing device. The memory stores a distance condition value for each type of a facility. The distance condition value indicates a distance determined based on the facility. The information processing device further includes a facility information receiver that receives facility information; the facility information contains facility location information and identification information. The facility location information indicates a location of the facility. The identification information identifies the type of the facility. The information processing device further includes a controller and a transmitter. The controller generates a first conversion result based on the current location information, the facility location information, and the distance condition value. The first conversion result indicates that a user is determined to have stayed in the facility. The transmitter transmits the first conversion result to an external apparatus.

According to a second aspect of the present disclosure, an information processing method is to be performed by an information processing device. The information processing device includes a memory that stores facility location information regarding a facility, a controller that determines whether a user has stayed in the facility, and a transmitter that transmits information to an external apparatus. In the information processing method of the present disclosure, current location information that indicates a current location of the information processing device is acquired. A distance condition value that indicates a distance determined based on the facility is stored for each type of the facility. Facility information that contains facility location information and identification information is received. The facility location information indicates a location of the facility. The identification information identifies the type of the facility. In addition, in the information processing method, a first conversion result indicating that the user has stayed in the facility is generated based on the current location information, the facility location information, and the distance condition value. The first conversion result is transmitted to the external apparatus.

According to a third aspect of the present disclosure, an information processing device includes a notification information distributor and a conversion information collector. The notification information distributor distributes facility location information that indicates a location of a facility, and the conversion information collector collects information regarding whether a user has taken action, based on notification information containing the facility location information. The information processing device further includes a speed/location information collector and a memory. The speed/location information collector collects location information and speed information regarding a computer connected to the information processing device via a network and notifies a condition determiner of the location information and the speed information. The memory stores a conversion condition, the conversion condition including a condition for generating a conversion in which a user is determined to have stayed in a facility. The information processing device further includes the condition determiner that, when determining that the location information and the speed information satisfy the conversion condition, generates a result of the conversion and notifies the conversion information collector of the generated result.

The information processing device of the present disclosure is effective in estimating the effectiveness of distributed advertisements.

### BRIEF DESCRIPTION OF DRAWINGS

FIG. 1 schematically illustrates an overall configuration of an advertising system according to a first exemplary embodiment;

FIG. 2 illustrates a configuration of notification information used by the advertising system according to the first exemplary embodiment and a third exemplary embodiment;

FIG. 3 is a flowchart of an operation of the information processing device in the advertising system according to the first and third exemplary embodiments in response to a first conversion;

FIG. 4 is a flowchart of an operation of the information processing device in the advertising system according to the first exemplary embodiment in response to a second conversion;

FIG. 5 is a flowchart of an operation in which the advertising system according to the first exemplary embodiment changes conversion conditions;

FIG. 6 schematically illustrates a configuration of a condition storing section of a memory in an information processing device in an advertising system according to a second exemplary embodiment;

FIG. 7 schematically illustrates an overall configuration of an advertising system according to the third exemplary embodiment; and

FIG. 8 is a flowchart of an operation of the advertising system according to the third exemplary embodiment in response to a second conversion.

### DETAILED DESCRIPTION

Exemplary embodiments will be described in detail below with reference to the accompanying drawings as appropriate. However, an unnecessarily detailed description will not be described in some cases. For example, in some cases, already well-known matters will not be described in detail, and substantially identical configurations will not be described again. This is to avoid the following description from being unnecessarily redundant and thus to help those skilled in the art to easily understand the description.

It should be noted that the following description and the accompanying drawings are provided to allow those skilled in the art to fully understand the present disclosure, and are not intended to limit the subject matter described in the claims.

### First Exemplary Embodiment

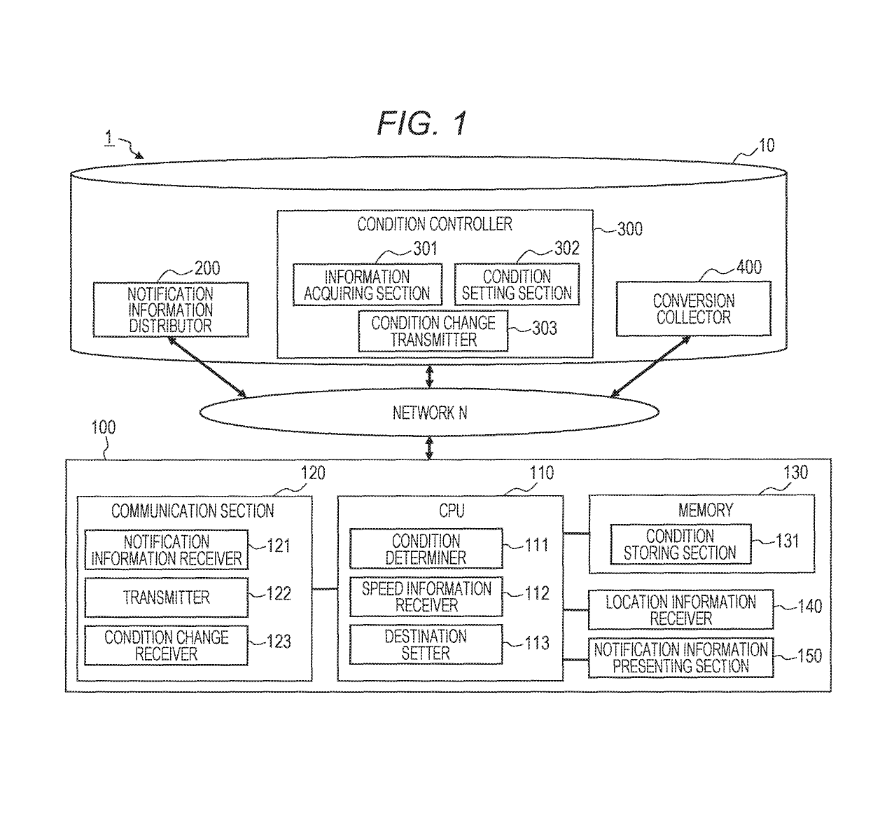

A first exemplary embodiment will be described below with reference to FIG. 1 to FIG. 5.

### 1-1. Configuration

### 1-1.1. Overall Configuration of Advertisement System

FIG. 1 schematically illustrates an overall configuration of advertising system 1 according to a first exemplary embodiment. Advertising system 1 includes server 10 and information processing device 100 connected to server 10 via network N.

Information processing device 100 may be a mobile terminal, such as a car navigation system, a portable phone, or a personal digital assistant (PDA). In the first exemplary embodiment, information processing device 100 is a car navigation system. Information processing device 100 is connected to notification information distributor 200, condition controller 300, and conversion information collector 400 in server 10 via network N.

Network N may be, for example, the Internet, Ethernet (registered trademark), a wireless local area network (WLAN), a data communication network for portable phones, or any other computer network.

### 1-1-2. Configuration of Server

A description will be given of notification information distributor 200, condition controller 300, and conversion information collector 400 in server 10 in the first exemplary embodiment. Each of notification information distributor 200, condition controller 300, and conversion information collector 400 may be constructed by a control circuit, such as a central processing unit (CPU), and implements their functions in accordance with specific programs. Furthermore, notification information distributor 200, condition controller 300, and conversion information collector 400 may be mounted in different servers.

Notification information distributor 200 distributes advertising information (exemplary notification information 201 described later) and facility location information (point of interest; referred to below as “POI”) to information processing device 100. The advertising information indicates an advertisement of products treated by the facility, and the facility location information indicates the location of the facility. Examples of the facility include a shop, a parking space, a gas station, a sightseeing facility, a hospital, a movie theater, a library, a hotel, a golf course, a ski site, an amusement park, an art gallery, and a museum. The facility location information may contain information regarding a parking space near the facility.

Condition controller 300 controls conditions for determining whether a user has taken action based on notification information 201 sent from notification information distributor 200.

Conversion information collector 400 collects information regarding whether a user has taken action based on notification information 201 sent from notification information distributor 200.

The term “conversion” discussed herein refers to a final result that can be acquired through, for example, a commercial Web site. To give an example, if this Web site is a translated Web page for commerce, the purchase of a product may correspond to the conversion. To give another example, if the Web site is a translated Web page for information service or a community, membership registration may correspond to the conversion. A primary effect of attracting-customers, such as receiving a request for a leaflet or an inquiry from customers, may be regarded as the conversion. In addition, conversion information collector 400 may collect a conversion rate, which is the ratio of the number of accesses resulting in the conversion to the total number of accesses to the Web page. The conversion in the first exemplary embodiment corresponds to user's actions of: setting a destination for a car navigation system based on advertising information received by information processing device 100; and, after setting the destination for the car navigation system, utilizing a facility associated with (designated by) the advertising information.

### 1-1-3. Configuration of Information Processing Device

As illustrated in FIG. 1, information processing device 100 in the first exemplary embodiment includes central processing unit (CPU) 110, which is an exemplary controller or control circuit, communication section 120, memory 130, location information receiver 140, and notification information presenting section 150. CPU 110 includes condition determiner 111, speed information receiver 112, and destination setter 113 and implements their functions in accordance with specific programs. Communication section 120 serves as a communication interface for communication via network N and includes notification information receiver 121, transmitter 122, and condition change receiver 123. Memory 130 includes condition storing section 131.

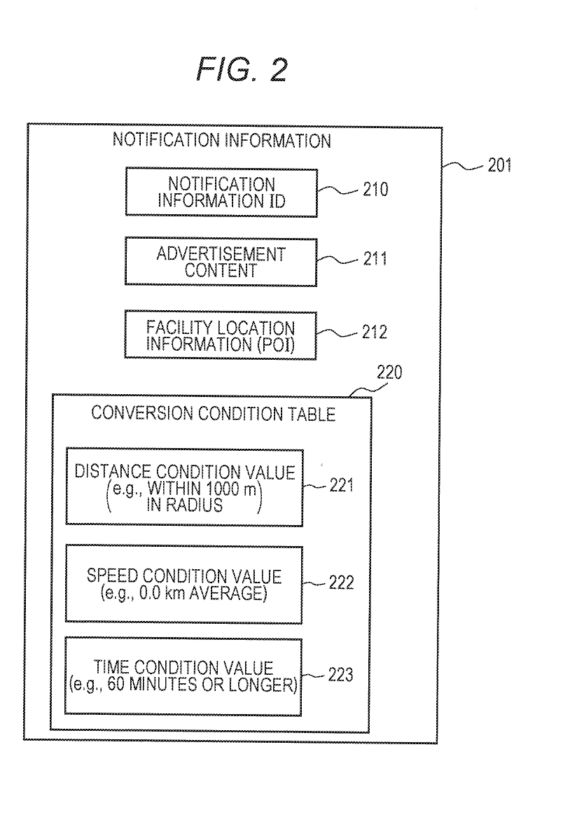

Condition determiner 111 compares location information and a moving speed of information processing device 100 with the corresponding conditions stored in conversion condition table 220 (see FIG. 2) contained in notification information 201. The location information is acquired from location information receiver 140. The moving speed is acquired from speed information receiver 112. Then, based on the comparison result, condition determiner 111 determines whether the conversion is established.

To acquire a moving speed of information processing device 100, speed information receiver 112 may acquire information on locations of information processing device 100 at two or more sites and determine an average speed by dividing the distance between the two sites by a time required to move between the sites. The resultant average speed may be regarded as the moving speed. If information processing device 100 is installed in a car, speed information receiver 112 may acquire the moving speed from the car. Destination setter 113 sets facility location information (POI) 212 (see FIG. 2) contained in notification information 201 as a destination. Then, destination setter 113 guides a user along a route to this destination. In this case, the user may set facility location information 212 contained in notification information 201 as a destination by using an interface, such as an infrared remote control, a touch panel, or physical buttons.

Notification information receiver 121 receives notification information 201 sent from notification information distributor 200 via network N. When a conversion is established, transmitter 122 transmits a conversion notification to conversion information collector 400 via network N. Condition change receiver 123 sequentially receives conversion conditions, which change depending on traffic congestion on a road, a usage situation of a parking space linked to a destination, or a weather condition, for example.

Condition storing section 131 extracts conversion conditions from distributed notification information 201 and stores these conversion conditions. Condition storing section 131 is disposed in memory 130. Examples of memory 130 include a semiconductor memory such as a random access memory (RAM) or a flash memory, a hard disk, and an optical disc.

Location information receiver 140 acquires information on a current location of information processing device 100. Location information receiver 140 may be a global positioning system (GPS) or some other system that pinpoints a location of a desired object by using a radio wave communication such as WiFi or Bluetooth (registered trademark) or by using a radio wave received via a communication network for movable bodies.

Notification information presenting section 150 presents a user with advertising content contained in received notification information 201. To give an example, if the advertising content is character information or a moving image, notification information presenting section 150 may be a display device. To give another example, if the advertising content is sound information, notification information presenting section 150 may be a speaker. Alternatively, if the advertising content is character information, notification information presenting section 150 may be a speaker equipped with a text-to-speech reading function.

1-1-4. Configuration of Notification Information

FIG. 2 illustrates a configuration of notification information 201 for advertising system 1 according to the first exemplary embodiment. Notification information 201 contains notification information identification (ID) 210, advertising content 211, facility location information (POI) 212, and conversion condition table 220.

Notification information ID 210 is identification for uniquely identifying notification information 201. Notification information ID 210 is also identification for identifying the type of a facility related to notification information 201. Advertising content 211 expresses facility information indicated by notification information 201 by using character information, moving images, still images, sound, or the like. Facility location information (POI) 212 is POI information that expresses the location of a facility indicated by notification information 201. Notification information 201 contains a plurality of conversion conditions. Conversion condition table 220 has distance condition value 221, speed condition value 222, and time condition value 223. Distance condition value 221 is a condition value that specifies a specific distance range that depends on the type of a facility; POI indicated by facility location information (POI) 212 corresponds to a starting point within this predetermined distance range. To give an example, if the facility is a convenience store, distance condition value 221 is set to a relatively small value, because many similar shops are likely to be present nearby. To give another example, if the facility is a large shopping mall, distance condition value 221 is set to a relatively large value, because it is likely that other similar shops are not present nearby and its parking space is apart from the POI. Speed condition value 222 is a condition value that specifies an average speed of information processing device 100. The average speed at which a conversion is to be established is typically 0 km/h. Time condition value 223 is an elapsed time over which speed condition value 222 meets the requirement for a conversion to be established. Time condition value 223 indicates the time which a user is likely to spend for utilizing the facility, which is determined according to the type of the facility. To give an example, if the facility is a convenience store, time condition value 223 may be set to a relatively small value, such as at least five minutes, because a user is less likely to stay there for a long time. To give another example, if the facility is a large shopping mall that has a large area or is a long distance away from its parking space, the time condition value 223 may be set to a relatively large value, such as at least thirty minutes. In addition, time condition value 223 may be set depending on a traffic situation in the vicinity of POI indicated by facility location information 212. More specifically, if the user is held up in a traffic jam, it may cause time condition value 223 to be reached before the user starts to utilize the facility. In order for a user to avoid this, time condition value 223 may be changed into an appropriate value. It should be noted that conversion condition table 220 does not necessarily have to contain all of distance condition value 221, speed condition value 222, and time condition value 223. Alternatively, conversion condition table 220 may contain at least distance condition value 221.

### 1-2. Operation

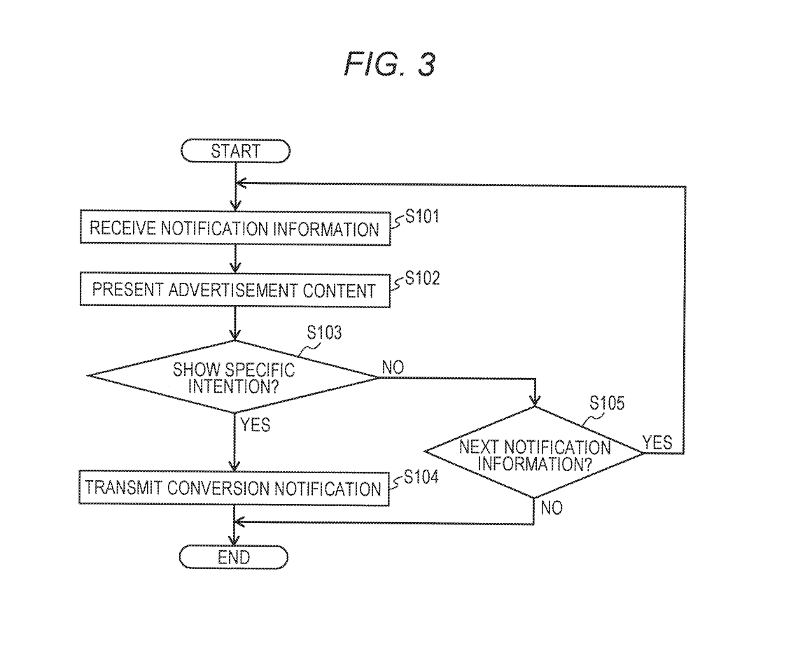

An operation of information processing device 100 configured above will be described below with reference to flowcharts in FIG. 3 to FIG. 5.

### 1-2-1. Distribution of Notification Information and Notification of First Conversion

FIG. 3 is a flowchart of an operation of information processing device 100 in advertising system 1 according to the first exemplary embodiment in response to a first conversion.

At Step S101, notification information receiver 121 in information processing device 100 receives a piece of notification information 201 from notification information distributor 200 via network N.

After having received the piece of notification information 201, at Step S102, notification information presenting section 150 presents a user with advertising content 211 contained in the piece of notification information 201. If the user indicates a specific intention against the presentation of advertising content 211, destination setter 113 sets a destination in accordance with the indicated intention. The expression “specific intention” discussed herein refers to an agreement that information processing device 100 will go to a place contained in advertising content 211. Examples of the specific intention include: inputting of information or sound through an input device; and no response to the presentation of advertising content 211 over a preset period.

At Step S103, destination setter 113 determines whether the user has indicated the specific intention against the presentation of advertising content 211. If having received the specific intention (Yes at Step S103), destination setter 113 sets POI information contained in the presented advertising content 211 as a destination. In this case, condition determiner 111 determines that a first conversion occurs. At Step S104, transmitter 122 transmits a conversion notification, together with notification information ID 210, to conversion information collector 400 via network N.

If not receiving the specific intention (No at Step S103), at Step S105, destination setter 113 inquires of the user whether to present another piece of notification information. If the user does not request another piece of notification information (No at Step S105), advertising system 1 terminates the operation. If the user requests another piece of notification information (Yes at Step S105), notification information receiver 121 receives a new piece of notification information at Step S101.

### 1-2-2. Notification of Second Conversion

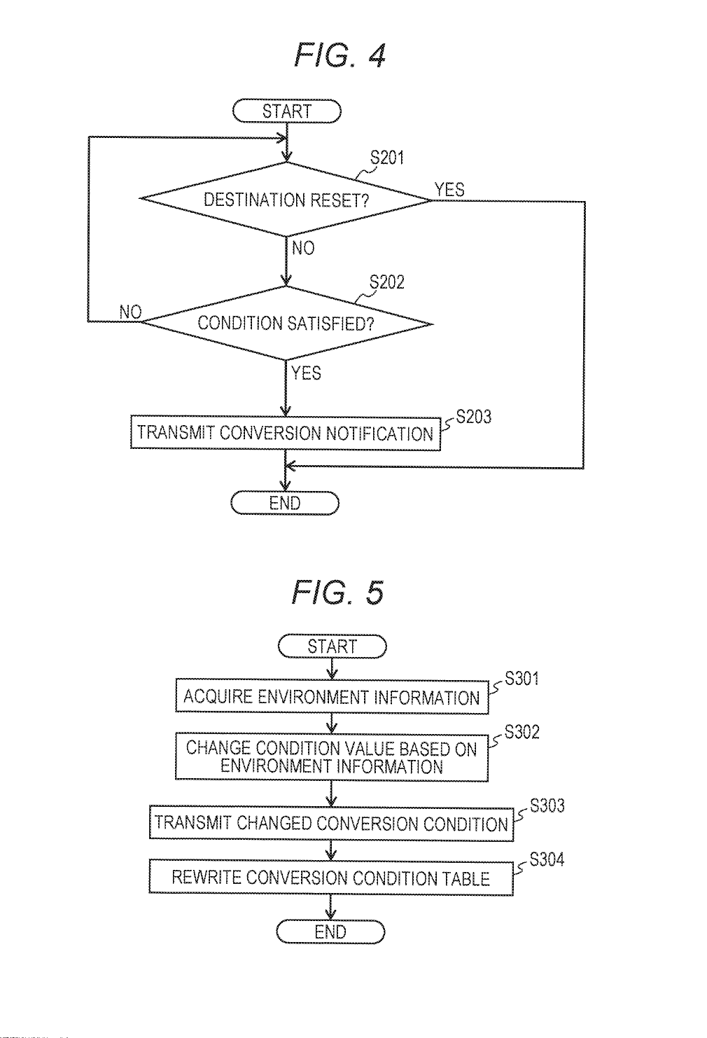

After the first conversion has occurred, information processing device 100 monitors whether a second conversion occurs. A description will be given below of an operation of information processing device 100 in response to a second conversion, with response to FIG. 4. FIG. 4 is a flowchart of an operation of information processing device 100 in advertising system 1 according to the first exemplary embodiment in response to a second conversion.

After the first conversion has occurred, at Step S201, information processing device 100 determines whether the destination that has been set in information processing device 100 (car navigation system) is reset. If the user changes or deletes the destination or if the car starts moving without navigation by the car navigation system, information processing device 100 determines that the destination is reset (Yes at Step S201), and then terminates the operation.

If the destination has not been reset (No at Step S201), at Step S202, condition determiner 111 continuously compares conversion condition table 220 stored in condition storing section 131 with a current location and moving speed of information processing device 100. In this case, the current location is acquired from location information receiver 140, and the moving speed is acquired from speed information receiver 112. As the result of the comparison, at Step S202, condition determiner 111 determines whether the conditions in conversion condition table 220 are satisfied. If condition determiner 111 determines that the conversion conditions are not satisfied (No at Step S202), information processing device 100 returns its operation to Step S201, and then condition determiner 111 starts monitoring whether the destination is reset.

If determining that the conversion conditions are satisfied (Yes at Step S202), condition determiner 111 generates a conversion result. At Step S203, transmitter 122 in information processing device 100 transmits a notification of a second conversion, together with notification information ID 210, to conversion information collector 400.

### 1-2-3. Change of Conversion Condition

Next, a description will be given of an operation of the advertising system 1 when conversion conditions are changed in accordance with surrounding environment, with reference to the flowchart of FIG. 5. FIG. 5 is a flowchart of an operation in which advertising system 1 according to the first exemplary embodiment changes conversion conditions.

At Step S301, information acquiring section 301 in condition controller 300 in server 10 acquires various pieces of environment information via network N. Examples of the pieces of environment information include: weather information regarding current weather, an ambient temperature, and humidity in the vicinity of the information processing device 100; information regarding parking congestion; and information regarding a traffic jam on a road.

At Step S302, condition setting section 302 in server 10 changes the condition values in conversion condition table 220 based on the acquired environment information. To give an example, if the weather information acquired from information acquiring section 301 via network N is changed from “sunny” into “rain”, condition setting section 302 may determine that a longer time is required for the user to walk from a parking space to the facility. Then, condition setting section 302 may increase time condition value 223. To give another example, if the parking congestion increases, condition setting section 302 changes distance condition value 221 so as to expand the range of a parking space used to determine that the user has utilized the facility.

At Step S303, condition change transmitter 303 in server 10 transmits the changed conversion conditions, together with notification information ID 210 that has been used to identify the previous notification information, to condition change receiver 123 in information processing device 100.

At Step S304, CPU 110 rewrites a corresponding portion of conversion condition table 220 stored in condition storing section 131, which is identifiable by using notification information ID 210. In this case, notification information ID 210 is stored in condition storing section 131.

### 1-3. Function and Effect

According to the first exemplary embodiment described above, information processing device 100 includes location information receiver 140 and memory 130. Location information receiver 140 acquires current location information that indicates a current location of information processing device 100. Memory 130 stores, for each type of a facility, distance condition value 221 that indicates a specific distance based on the facility. Information processing device 100 further includes a receiver corresponding to notification information receiver 121 that receives facility information. The facility information contains facility location information 212 and identification information. The facility location information 212 indicates the location of the facility. The identification information is used to uniquely identify the type of the facility. Information processing device 100 further includes a controller and transmitter 122. The controller corresponds to CPU 110 that generates a first conversion result indicating that a user has stayed in the facility, based on the current location information, facility location information 212, and distance condition value 221. Transmitter 122 transmits the first conversion result to an external apparatus.

With the above configuration, information processing device 100 can measure the effect of attracting customers, produced by, notification information, such as a distributed advertisement, or determine whether such notification information has caused customers to come to the facility. Further, information processing device 100 can measure the effect of attracting customers completely, even though customers (users) do not have to tell the facility that the advertisement has caused them to come to the facility and neither does the facility have to tell an advertising provider that the advertisement has caused customers to come to the facility. Information processing device 100 can measure the effect of attracting customers with a simple configuration and without the need for installing additional equipment in a facility.

Information processing device 100 may further include speed information receiver 112 that acquires a moving speed of information processing device 100. Transmitter 122 may transmit the first conversion result at a point where the moving speed is zero. With this configuration, information processing device 100 can determine accurately whether the user has stayed in the facility.

Memory 130 may store time condition value 223 that indicates a preset time according to the facility information. The controller corresponding to CPU 110 compares the time condition value with a time period over which the moving speed is zero. If the time condition value is satisfied, the controller may generate the first conversion result. With this configuration, information processing device 100 can determine accurately whether the user has stayed in the facility.

Information processing device 100 may further include destination setter 113 that sets the facility location information as a destination. The controller corresponding to CPU 110 may guide a user along a route to the destination that has been set by destination setter 113. With this configuration, the user can set facility location information 212 as a destination.

Information processing device 100 may be connected to network N and change distance condition value 221 in accordance with information acquired via network N. With this configuration, for example, if a parking space is crowded, information processing device 100 can still determine accurately whether the user has stayed in the facility.

Information processing device 100 may be connected to network N and change time condition value 223 in accordance with information acquired via network N. With this configuration, if the weather gets worse in a region where the facility is present, for example, information processing device 100 can still determine accurately whether the user has stayed in the facility.

### Second Exemplary Embodiment

Advertising system 1 according to a second exemplary embodiment has substantially the same overall configuration as advertising system 1 according to the first exemplary embodiment. However, the second exemplary embodiment differs from the first exemplary embodiment, in that condition storing section 131 stores conversion condition tables 220 in advance and notification information 201 contains no conversion condition tables. Other components according to the second exemplary embodiment are the same as those according to the first exemplary embodiment; therefore, their descriptions will be skipped as appropriate.

### 2-1. Configuration

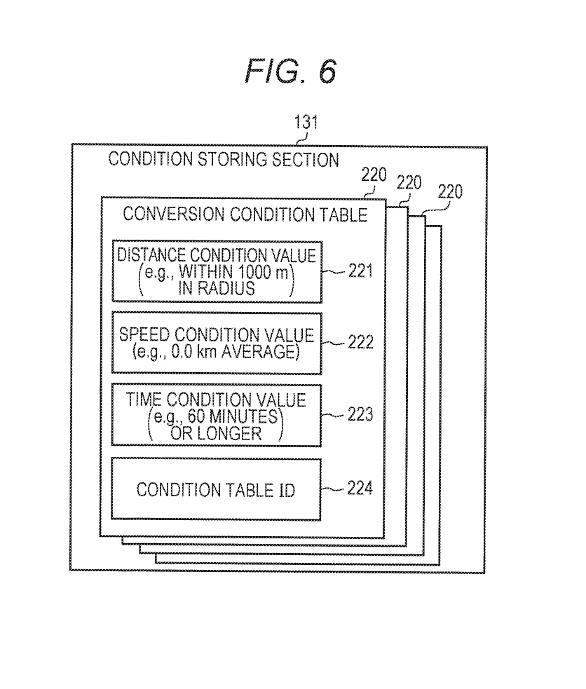

FIG. 6 schematically illustrates a configuration of condition storing section 131 in information processing device 100 in advertising system 1 according to the second exemplary embodiment. Condition storing section 131 stores, in advance, the plurality of conversion condition tables 220 related to respective types of a facility. Each of conversion condition tables 220 contains distance condition value 221, speed condition value 222, and time condition value 223 that are identifiable by using condition table ID 224 and are determined according to the type of a facility. Each condition table ID 224 contains identification information for uniquely identifying the corresponding conversion condition table 220. With condition table IDs 224, condition determiner 111 can uniquely identify which conversion condition table 220 in condition storing section 131 is to be used to determine whether conditions are satisfied, based on notification information ID 210 contained in notification information 201 received from server 10. Information processing device 100 can change conversion condition tables 220 in condition storing section 131 in accordance with a type of a facility which is linked to notification information 201. It should be noted that each conversion condition table 220 does not necessarily have to contain all of the condition values and may contain at least distance condition value 221.

### 2-2. Function and Effect

According to the second exemplary embodiment described above, information processing device 100 can measure the effect of attracting customers produced by notification information, such as a distributed advertisement, or determine whether such notification information has caused customers to come to a facility. Further, information processing device 100 can measure the effect of attracting customers completely, even though customers (users) do not have to tell the facility that the advertisement caused them to come to the facility and neither does the facility have to tell an advertising provider that the advertisement caused customers to come to the facility. Information processing device 100 can measure the effect of attracting customers with a simple configuration and without the need for installing additional equipment in a facility.

### Third Exemplary Embodiment

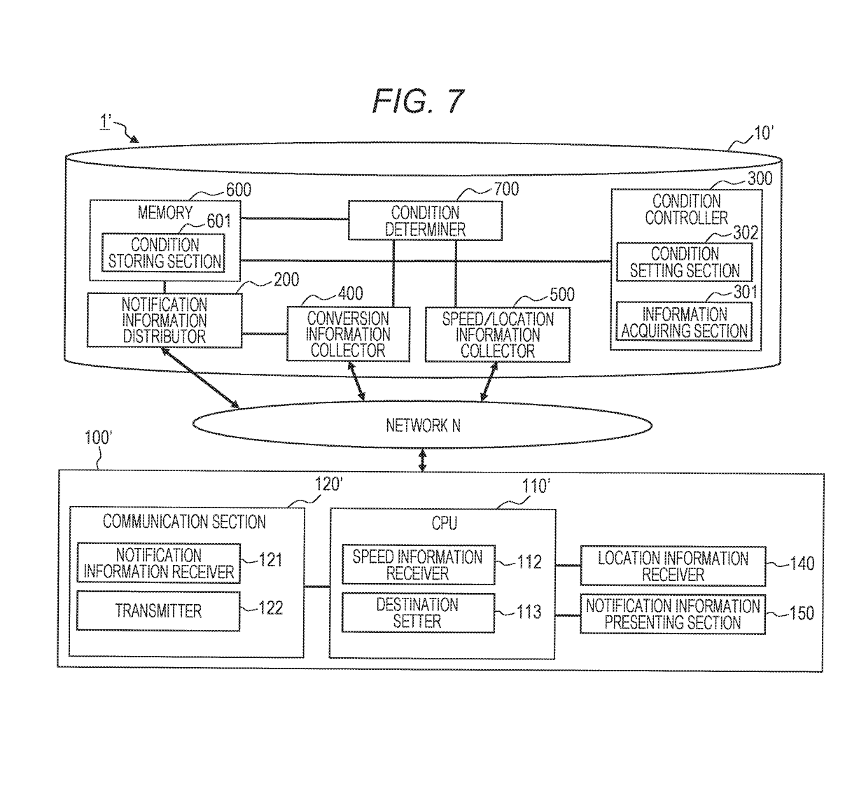

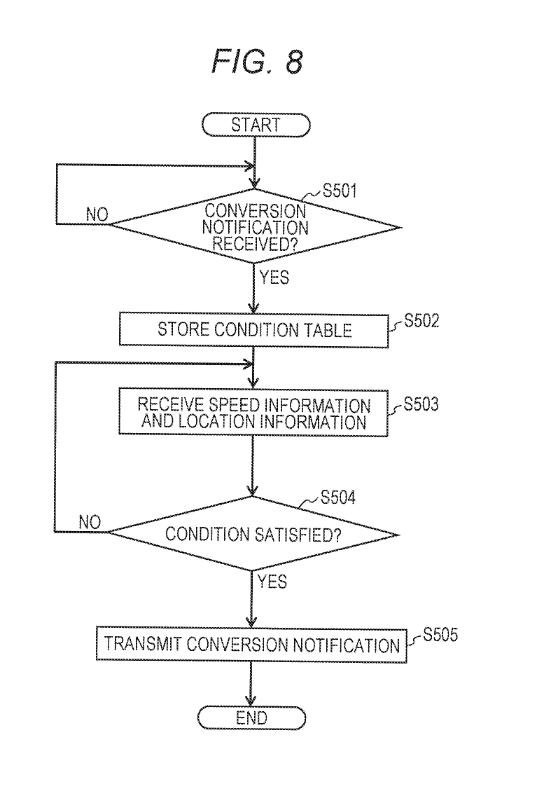

A third exemplary embodiment of the present disclosure will be described below with reference to FIG. 2, FIG. 3, FIG. 7, and FIG. 8.

### 3-1. Configuration

### 3-1-1. Overall Configuration of Advertisement System

FIG. 7 schematically illustrates an overall configuration of advertising system 1′ according to the third exemplary embodiment. FIG. 8 is a flowchart of an operation of advertising system 1′ in response to a second conversion. Advertising system 1′ includes server 10′ and information processing device 100′ connected to server 10′ via network N.

Hereinafter, components substantially identical to those in the first and second exemplary embodiments are given the same reference characters, and their descriptions will be skipped as appropriate.

Information processing device 100′ may be a mobile terminal, such as a car navigation system, a portable phone, or a personal digital assistant (PDA). In the third exemplary embodiment, information processing device 100′ is a car navigation system. Information processing device 100′ is connected to notification information distributor 200, conversion information collector 400, and speed/location information collector 500 in server 10′ via network N.

The network N may be, for example, the Internet, Ethernet (registered trademark), a wireless local area network (WLAN), a data communication network for portable phones, or any other computer network.

### 3-1-2. Configuration of Server

A description will be given of server 10′ including notification information distributor 200, condition controller 300, conversion information collector 400, speed/location information collector 500, memory 600, and condition determiner 700, in the third exemplary embodiment. Each of notification information distributor 200, condition controller 300, conversion information collector 400, speed/location information collector 500, memory 600, and condition determiner 700 may be constructed by a control circuit, such as a central processing unit (CPU), and implements their functions in accordance with specific programs. Furthermore, notification information distributor 200, condition controller 300, conversion information collector 400, speed/location information collector 500, memory 600, and condition determiner 700 may be mounted in different servers.

Notification information distributor 200 distributes advertising information (exemplary notification information 201) and facility location information (point of interest; referred to below as “POI”) to information processing device 100′. The advertising information indicates an advertisement of products treated by a facility, and the facility location information indicates the location of the facility. Examples of the facility include a shop, a parking space, a gas station, a sightseeing facility, a hospital, a movie theater, a library, a hotel, a golf course, a ski site, an amusement park, an art gallery, and a museum. The facility location information may contain information regarding a parking space near the facility.

Condition controller 300 controls conditions for determining whether a user has taken action based on notification information 201 sent from notification information distributor 200.

Conversion information collector 400 collects information regarding whether a user has taken action based on notification information 201 sent from notification information distributor 200.

The term “conversion” discussed herein refers to a final result that can be acquired through, for example, a commercial Web site. To give an example, if this Web site is a translated Web page for commerce, the purchase of a product may correspond to the conversion. To give another example, if the Web site is a translated Web page for information service or a community, membership registration may correspond to the conversion. A primary effect of attracting customers, such as receiving a request for a leaflet or an inquiry from customers, may be regarded as the conversion. In addition, conversion information collector 400 may collect a conversion rate, which is the ratio of the number of accesses resulting in the conversion to the total number of accesses to the Web page. The conversion in the third exemplary embodiment corresponds to user's actions of: setting a destination for a car navigation system based on advertising information received by information processing device 100′; and, after setting the destination for the car navigation system, utilizing a facility associated with (designated by) the advertising information.

Speed/location information collector 500 receives speed information and location information from information processing device 100′ and notifies condition determiner 700 of the received speed information and location information.

Memory 600 includes condition storing section 601. Condition storing section 601 stores a conversion condition table contained in notification information 201 to be distributed. Examples of memory 600 include a semiconductor memory such as a random access memory (RAM) or a flash memory, a hard disk, and an optical disc.

Condition determiner 700 compares the location information and a moving speed of information processing device 100′ with the corresponding conditions stored in the conversion condition table contained in condition storing section 601. The location information and the moving speed are acquired from speed/location information collector 500. Then, based on the comparison result, condition determiner 700 determines whether the conversion is established.

### 3-1-3. Configuration of Information Processing Device

As illustrated in FIG. 7, information processing device 100′ in the third exemplary embodiment includes central processing unit (CPU) 110′, which is an exemplary controller or control circuit, communication section 120′, location information receiver 140, and notification information presenting section 150. CPU 110′ includes speed information receiver 112 and destination setter 113 and implements their functions in accordance with specific programs. Communication section 120′ serves as a communication interface for communicate via network N and includes notification information receiver 121 and transmitter 122.

Speed information receiver 112 acquires a moving speed of information processing device 100′. To acquire the moving speed, speed information receiver 112 may acquire information on locations of information processing device 100′ at two or more sites and determine an average speed by dividing the distance between the two sites by a time required to move between the sites. The resultant average speed may be regarded as the moving speed. If information processing device 100′ is installed in a car, speed information receiver 112 may acquire the moving speed from the car.

Similar to the first exemplary embodiment, destination setter 113 sets facility location information (POI) 212 contained in notification information 201 as a destination. Then, destination setter 113 guides a user along a route to this destination. In this case, the user may set facility location information 212 contained in notification information 201 as a destination by using an interface, such as an infrared remote control, a touch panel, or physical buttons.

Notification information receiver 121 receives notification information 201 distributed from notification information distributor 200 via network N. When a conversion is established, transmitter 122 transmits a conversion notification to conversion information collector 400 via network N.

Location information receiver 140 acquires information on a current location of information processing device 100′. Location information receiver 140 may be a global positioning system (GPS) or some other system that pinpoints a location of a desired object by using a radio wave communication, such as WiFi or Bluetooth (registered trademark) or by using a radio wave received via a communication network for movable bodies.

Notification information presenting section 150 presents a user with advertising content contained in received notification information 201. To give an example, if the advertising content is character information or a moving image, notification information presenting section 150 may be a display device. To give another example, if the advertising content is sound information, notification information presenting section 150 may be a speaker. Alternatively, if the advertising content is character information, notification information presenting section 150 may be a speaker equipped with a text-to-speech reading function.

### 3-1-4. Configuration of Notification Information

FIG. 2 illustrates a configuration of notification information 201 for advertising system 1′ according to the third exemplary embodiment. The configuration of notification information 201 is the same as that described in the first exemplary embodiment.

Similar to the second exemplary embodiment, the conversion condition table may include a plurality of tables related to respective types of a facility.

### 3-2. Operation

An operation of information processing device 100′ configured above will be described below with reference to flowcharts in FIG. 3 and FIG. 8.

### 3-2-1. Distribution of Notification Information and Notification of First Conversion

FIG. 3 is a flowchart of an operation of information processing device 100′ in advertising system 1′ according to the third exemplary embodiment in response to a first conversion.

At Step S101, notification information receiver 121 in information processing device 100′ receives a piece of notification information 201 from notification information distributor 200 via network N.

After having received the piece of notification information 201, at Step S102, notification information presenting section 150 presents a user with advertising content 211 contained in the piece of notification information 201. If the user indicates a specific intention against the presentation of advertising content 211, destination setter 113 sets a destination in accordance with the indicated intention. The expression “specific intention” discussed herein refers to an agreement that information processing device 100′ will go to a place contained in advertising content 211. Examples of the specific intention include: inputting of information or sound through an input device; and no response to the presentation of advertising content 211 over a preset period.

At Step S103, destination s setter 113 determines whether the user has indicated the specific intention against the presentation of advertising content 211. If having received the specific intention (Yes at Step S103), destination setter 113 sets POI information contained in the presented advertising content 211 as a destination. In this case, condition determiner 111 determines that a first conversion occurs. At Step S104, transmitter 122 transmits a conversion notification, together with notification information ID 210, to conversion information collector 400 via network N.

If not receiving the specific intention (No at Step S103), at Step S105, destination setter 113 inquires of the user whether to present another piece of notification information. If the user does not request another piece of notification information (No at Step S105), advertising system 1′ terminates the operation. If the user requests another piece of notification information (Yes at Step S105), notification information receiver 121 receives a new piece of notification information at Step S101.

### 3-2-2. Notification of Second Conversion

At Step S501, conversion information collector 400 in server 10′ determines whether to have received a first conversion notification from information processing device 100′. Conversion information collector 400 notifies notification information distributor 200 of the reception of the conversion. At Step S502, condition storing section 601 in memory 600 stores conversion condition table 220 contained in notification information 201.

At regular time intervals (e.g., every one second, every thirty seconds, every one minute, etc.), location information receiver 140 and speed information receiver 112 in information processing device 100′ transmit location information and speed information on information processing device 100′ to server 10′ via network N. At Step S503, speed/location information collector 500 in server 10′ receives and collects the location information and speed information on information processing device 100′. Then, speed/location information collector 500 notifies condition determiner 700 of the collected location information and speed information.

Condition determiner 700 continuously compares the current location and moving speed of information processing device 100′ with the corresponding conditions in conversion condition table 220 (FIG. 2) stored in condition storing section 601. Based on the comparison result, at Step S504, condition determiner 700 determines whether the conditions in conversion condition table 220 are satisfied. If condition determiner 700 determines that the conversion conditions are not satisfied (No at Step S504), server 10′ returns the operation to Step S503. If condition determiner 700 determines that the conversion conditions are satisfied (Yes at Step S504), condition determiner 700 generates a conversion result and notifies conversion information collector 400 of the generated conversion result at Step S505.

In the above operation, condition determiner 700 may monitor whether the destination that has been set in information processing device 100′ is reset, similar to the first exemplary embodiment. In this case, if information processing device 100′ accepts the reset of the destination after notifying the first conversion, information processing device 100′ may notify server 10′ that the destination has been reset. If the destination has been reset, server 10′ may terminate the operation.

### 3-2-3. Change of Conversion Condition

If the conversion conditions are changed, server 10′ skips Step S303 in FIG. 5, more specifically does not notify information processing device 100′ that the conversion conditions have been changed via network N. Instead, server 10′ directly rewrites the conversion condition table stored in condition storing section 601.

### 3-3. Function and Effect

According to the third exemplary embodiment described above, an information processing device corresponding to server 10′ includes notification information distributor 200 and conversion information collector 400. Notification information distributor 200 distributes facility location information 212 that indicates a location of a facility. Conversion information collector 400 collects information regarding whether a user has taken action based on notification information 201 containing facility location information 212. Moreover, the information processing device further includes speed/location information collector 500, memory 600, and condition determiner 700. Speed/location information collector 500 collects location information and speed information regarding a computer connected to server 10′ via a network and notifies condition determiner 700 of the location information and speed information. Memory 600 stores a conversion condition, which is a condition for generating a conversion in which a user is determined to stay in a facility. When determining that the location information and the speed information satisfy the conversion condition, condition determiner 700 generates a conversion result and notifies the conversion information collector of the generated conversion result.

With the above configuration, the information processing device can measure the effect of attracting customers produced by notification information, such as a distributed advertisement, or determine whether such notification information caused customers to come to a facility. Further, information processing device 100 can measure the effect of attracting customers completely even though customers (users) do not have to tell the facility that the advertisement has caused them to come to the facility and neither does the facility have to tell an advertising provider that the advertisement has caused customers to come to the facility.

### Other Exemplary Embodiments

The first to third exemplary embodiments, which are examples of techniques disclosed in the present application, have been described. However, the techniques in the present disclosure are not limited to these exemplary embodiments and are applicable to exemplary embodiments that undergo any modifications, variations, replacements, additions, and omission, for example. Furthermore, the components in the first to third exemplary embodiments may be combined to create another exemplary embodiment. Hereinafter, other exemplary embodiments will be described.

In the first to third exemplary embodiments described above, the condition under which the first conversion is satisfied is that destination setter 113 determines that a user has indicated a specific intention against the presentation of advertising content 211 at Step S103 in FIG. 3. However, this is not the only option for the condition under which the first conversion is satisfied; alternatively, the condition may be that there is an operation by a user to bookmark advertising content 211 or add advertising content 211 to his/her favorite list. With the conversion satisfaction condition being set in this manner, information that is effective in knowing users' consumption behaviors can be obtained. In this case, information processing device 100 or 100′ may determine that the second conversion is satisfied, based on whether a bookmarked destination has been set for the car navigation system, without determining whether the destination is reset as at Step S201 in FIG. 4. With this configuration, information processing device 100 or 100′ can measure the effect of attracting customers, even in a case where a user does not set a destination as soon as receiving notification information 201 but only adds the received notification information 201 to his/her favorite list.

In the first to third exemplary embodiments described above, information processing device 100 or 100′ determines whether a conversion is made, but this is not the only option. Server 10 or 10′ may determine whether a conversion is made. This configuration can be achieved without a new application to be added to information processing device 100 or 100′.

As described above, a CPU is used as an exemplary controller; however, a micro processing unit (MPU) may be used instead. Alternatively, an integrated circuit (IC), such as an application specific integrated circuit (ASIC) or a field programmable gate array (FPGA) may be used. Thus, the configuration of the controller should not be limited to these configurations, and the controller may have an arbitrary configuration, such as a hard logic circuit.

In the first to third exemplary embodiments described above, speed condition value 222, which is a conversion condition for a speed, is set to 0 km/h. However, if information processing device 100 or 100′ is a smartphone or some other mobile device, speed condition value 222 does not necessarily have to be 0 km/h. This is because a conversion can be satisfied even when a user walks within a large shopping mall. In this case, a condition specified by speed condition value 222 within an area specified by distance condition value 221 may be ignored and a conversion may be determined to be satisfied.

When information processing device 100 or 100′ of the present disclosure is a navigation system installed in a car, for example, information processing device 100 or 100′ may be connected to an application programming interface (API) for the car and acquire various driving conditions of the car, including a moving speed, a steering angle, an engine rotation frequency, information regarding a brake, openings of windows, and living body information on a driver. Using such driving conditions help information processing device 100 or 100′ to measure the effect of attracting customers with greater precision.

The foregoing exemplary embodiments are examples used to describe techniques in the present disclosure and therefore can undergo various modifications, variations, replacements, additions, and omissions within the scopes of claims and their equivalents.

The present disclosure is applicable to information processing devices that measure the effect of attracting customers. More specifically, the present disclosure is applicable to a car navigation system, a smartphone, a PDA, a tablet PC, and any other similar devices.

What is claimed is:

1. An information processing device comprising:
a location information receiver that acquires current location information indicating a current location of the information processing device;
a memory that stores a distance condition value for each type of a facility, the distance condition value indicating a distance determined based on the facility;
a facility information receiver that receives facility information containing facility location information and identification information, the facility location information indicating a location of the facility, the identification information identifying the type of the facility;
a controller that generates a first conversion result based on the current location information, the facility location information, and the distance condition value, the first conversion result indicating that a user is determined to have stayed in the facility; and
a transmitter that transmits the first conversion result to an external apparatus.

2. The information processing device according to claim 1, further comprising a speed information receiver that acquires a moving speed of the information processing device,
wherein the transmitter transmits the first conversion result at a point where the moving speed is zero.

3. The information processing device according to claim 2, wherein
the memory stores a time condition value that indicates a time determined according to the facility information, and
the controller compares the time condition value with a time period over which the moving speed is zero and, when the time condition value is satisfied, generates the first conversion result.

4. The information processing device according to claim 1, further comprising a destination setter that sets the facility location information as a destination,
wherein the controller guides the user along a route to the destination set by the destination setter.

5. The information processing device according to claim 1, wherein
the information processing device is connected to a network, and
the distance condition value is changed in accordance with information acquired via the network.

6. The information processing device according to claim 1, wherein
the memory stores a time condition value satisfying a condition under which the first conversion result is generated, the time condition value indicating a time determined according to the facility information,
the information processing device is connected to a network, and
the time condition value is changed in accordance with information acquired via the network.

7. The information processing device according to claim 6, wherein
the memory stores a speed condition value indicating a speed of the information processing device that satisfies a condition under which the first conversion result is generated,
the information processing device is connected to the network, and
the speed condition value is changed in accordance with information acquired via the network.

8. The information processing device according to claim 4, wherein
when the facility information is set as the destination, the controller generates a second conversion result,
the transmitter transmits the second conversion result to an external apparatus, and
when the controller has generated the second conversion result, the controller generates the first conversion result based on the current location information, the facility location information, and the distance condition value.

9. The information processing device according to claim 8, wherein
when the destination is changed after the controller has generated the second conversion result, the controller does not generate the first conversion result.

10. An information processing method performed by an information processing device including a memory that stores facility location information regarding a facility, a controller that determines whether a user has stayed in the facility, and a transmitter that transmits information to an external apparatus, the information processing method comprising:
acquiring current location information indicating a current location of the information processing device;
storing a distance condition value for each type of the facility, the distance condition value indicating a distance determined based on the facility;
receiving facility information containing facility location information and identification information, the facility location information indicating a location of the facility, the identification information identifying the type of the facility;
generating a first conversion result based on the current location information, the facility location information, and the distance condition value, the first conversion result indicating that the user has stayed in the facility; and
transmitting the first conversion result to the external apparatus.

11. The information processing method according to claim 10, further comprising:
acquiring a moving speed of the information processing device; and
transmitting the first conversion result at a point where the moving speed is zero.

12. The information processing method according to claim 11, further comprising:
storing, in the memory, a time condition value indicating a time determined according to the facility information;
comparing the time condition value with a time period over which the moving speed is zero; and
generating the first conversion result when the time condition value is satisfied.

13. The information processing method according to claim 10, further comprising:
setting the facility location information as a destination; and
guiding the user along a route to the set destination.

14. The information processing method according to claim 10, further comprising:
acquiring information via a network; and
changing the distance condition value in accordance with the information acquired via the network.

15. The information processing method according to claim 10, further comprising:
storing, in the memory, a time condition value that satisfying a condition under which the first conversion result is generated, the time condition value indicating a time determined according to the facility information;
acquiring information via a network; and
changing the time condition value in accordance with the information acquired via the network.

16. The information processing method according to claim 15, further comprising:
storing, in the memory, a speed condition value indicating a speed of the information processing device that satisfies a condition under which the first conversion result is generated;
allowing the information processing device to connect to the network; and
changing the speed condition value in accordance with the information acquired via the network.

17. The information processing method according to claim 13, further comprising:
generating a second conversion result when the facility information is set as the destination;
transmitting the second conversion result to an external apparatus; and
generating, when the second conversion result has been generated, the first conversion result based on the current location information, the facility location information, and the distance condition value.

18. The information processing method according to claim 17, wherein,
when the destination is changed after the second conversion result has been generated, the first conversion result is not generated.

19. An information processing device comprising:
a notification information distributor that distributes facility location information indicating a location of a facility;
a conversion information collector that collects information regarding whether a user has taken action based on notification information containing the facility location information;
a speed/location information collector that collects location information and speed information regarding a computer connected to the information processing device via a network and notifies a condition determiner of the location information and the speed information;
a memory that stores a conversion condition, the conversion including a condition for generating a conversion in which the user is determined to have stayed in the facility; and
the condition determiner that, when determining that the location information and the speed information satisfy the conversion condition, generates a result of the conversion and notifies the conversion information collector of the generated result.
